(19) United States
(12) Patent Application Publication
(10) Pub. No.: US 2003/0177622 A1
(43) Pub. Date: Sep. 25, 2003

(54) Combined fastening removal and retrieval device and method of using same

(75) Inventors: Dean L. Kamen, Bedford, NH (US); Kingston Owens, Bedford, NH (US)

Correspondence Address: DEAN L. KAMEN, DEKA RESEARCH & DEVELOPMENT, 340 COMMERCIAL STREET, MANCHESTER, NH, 03101, US

(73) Assignee: DEKA Research & Development Corp.

(21) Appl. No.: 10/102,484

(22) Filed: Mar. 20, 2002

(51) Int. Cl. F16B 15/00

(52) U.S. Cl. 24/703.5

(57) ABSTRACT

A method of removing and retrieving a staple or other fastening device for a plurality of objects, commonly paper, without the use of additional tools. The combined fastening removal and retrieval device comprises a tab of tear-resistant material that is placed on top of or around the objects being stapled or otherwise fastened together. The combination of the stack of papers and the combined fastening removal and retrieval device is then fastened together to form a single object. To remove the fastening device, the user pulls on the tab, which in turn pulls on the fastening device, such as a staple, until the staple or other fastening device is removed from the stack of papers. An additional benefit is that the staple will remain attached to the fastening removal device.

### TECHNICAL FIELD

The present invention relates to a combined fastener removal and retrieving device and more particularly, to a combined staple removing and retrieving device.

### BACKGROUND INFORMATION

A common method and economical means of fastening several objects together is with the use of a fastening device such as a staple. Unfortunately, the staple must often be removed for a wide variety of reasons. This presents a problem because the objects which are fastened together, usually paper, often become damaged during the process of removing the fastener. Generally the individual removing the staple will need a tool since it is very difficult to remove staples by hand.

The most common staple remover is a claw-like device such as the one described in U.S. Pat. Nos. 3,974,999 to Bertolet or 5,875,503 to Cheldin that have opposing pairs of claws that are forced between the staple and the paper, forcing the bent legs of the staple to be straightened and removed.

Another prior art staple remover is a blade of increasing width that is slid between the staple and the paper such as those described in U.S. Pat. Nos. 4,553,737 to Yi or 4,901,981 to Knippels or 5,720,062 to Vaught. As the blade is slid or inserted between the staple and the paper, the increasing width of the blade causes the staple to be lifted through the stapled papers.

The disadvantage of both devices is that you still need a tool to remove the staple. Another disadvantage is that the claw-like staple remover usually damages the paper if the claws accidentally dig into the papers. A further disadvantage is that the removed staple is easily dropped or lost and since most staple removing is done at a copier machine, the removed staple may become lodged inside and damage the copier machine.

Accordingly, what is needed is a method/device for removing a fastening means without the use of a tool. Also, there is a need for a method/device for removing a fastening device that will not damage the previously fastened objects. Further, there is a need for a method/device for removing and automatically recovering a fastening device.

### SUMMARY OF THE INVENTION

One embodiment of the present invention is a combined fastening removal and retrieval device comprising a portion of a tear-resistant material. The combined fastening removal and retrieval device has an inner surface and an outer surface and a length. The combined fastening removal and retrieval device is preferably rectangular in shape, although additional shapes are contemplated. The combined fastening removal and retrieval device is placed at least on the top of the objects prior to being fastened. During the fastening, the combined fastening removal and retrieval device is secured to the objects by the fastener.

Another embodiment of the present invention utilizes a crease in the tear-resistant material. The crease creates a front tab and a back tab. The front tab end and the rear tab end are placed on the top and bottom respectively of the objects being fastened in a manner such that the combined fastening removal and retrieval device partially surrounds a portion of the objects where the fastening device is to be placed.

The tear-resistant material can be of any material having suitable strength to withstand the force generated during the removal process such as acetate, fluropolymers, PEEK, MYLAR, polycarbonate, polyester (PET, PET G), polyethylene (LDPE), or PVC. The only limitation being that the material must be in a form suitable for a think film.

### BRIEF DESCRIPTION OF THE DRAWINGS

These and other features and advantages of the present invention will be better understood by reading the following detailed description, taken together with the drawings wherein:

FIG. 1 is an embodiment of the present invention;

FIGS. 2A, 2B, and 2C are plain views showing three different embodiments of the present invention;

FIGS. 3A and 3B are plain views showing two different dispensing embodiments of the present invention including a roll holder and a stack;

FIG. 4 is another embodiment of the present invention;

FIG. 5 is a plain view showing an embodiment of the present invention in combination with a plurality of objects prior to being fastened;

FIG. 6 is a plain view showing an embodiment of the present invention in combination with a plurality of objects after being fastened;

FIG. 7 is a plain view showing an embodiment of the present invention in combination with a plurality of objects during one removal method of a fastening device; and

FIG. 8 is a plain view showing an embodiment of the present invention in combination with a plurality of objects after removal of a fastening device.

### DETAILED DESCRIPTION OF THE PREFERRED EMBODIMENTS

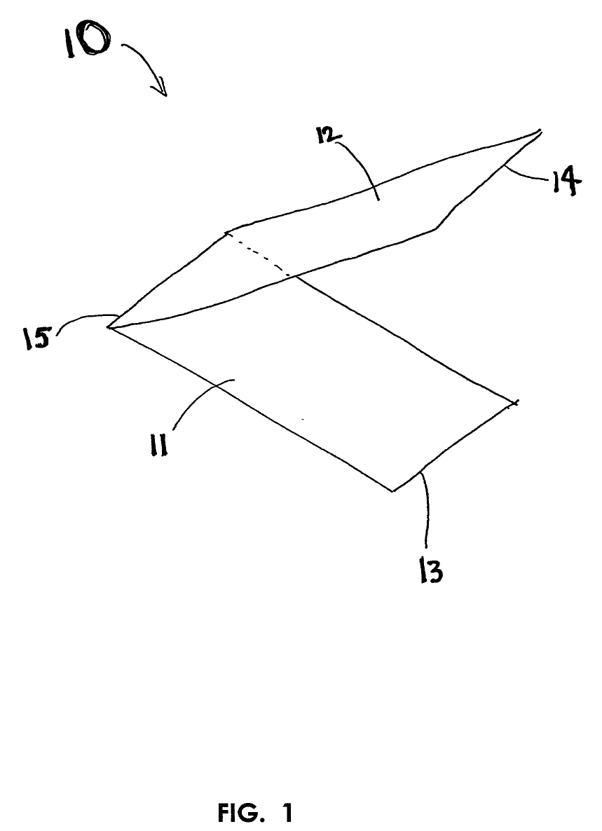

The present invention includes a device 10, FIG. 1, and a method for removing and retrieving a fastening device without the need for an additional tool. In one embodiment of the present invention, a combined fastening removal and retrieval device 10 is constructed of a portion of tear-resistant material having an inner surface 11, an outer surface 12, a back tab end 13, a front tab end 14, and a transverse crease 15 disposed between and forming the back tab end 13 and the front tab end 14.

The combined fastening removal and retrieval device 10 may be composed of a polymeric material such as mylar, acetate, or as a composite such as a fiber reinforced composite or laminate composite such as polypropylene film with fiberglass or polypropylene filament or any other tear-resistant material capable of withstanding the force generated during removal. The thickness of the combined fastening removal and retrieval device 10 will depend on the material chosen and on the strength and tearing properties of the material. The selection of the material and its thickness is well within the knowledge of one of ordinary skill in the materials art. In a preferred embodiment, the material is Mylar having a thickness of generally between 1 mil. to 4 mil.

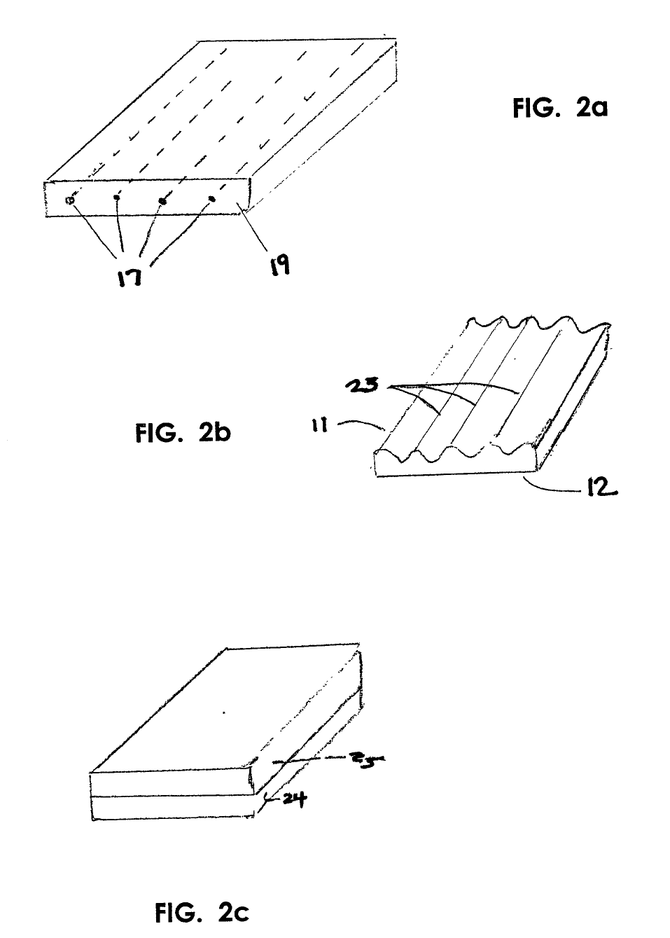

FIGS. 2A, 2B, and 2C illustrate three different material embodiments of the combined fastening removal and retrieval device 10. In one embodiment, FIG. 2A, the material may be a composite material containing fibers 17 embedded in the polymer matrix 19 and orientated along the length of the combined fastening removal and retrieval device 10 for providing additional strength along the length of the device 10 to prevent tearing of the removal device 10 as the fastening device is removed.

In another embodiment, FIG. 2B, the combined fastening removal and retrieval device 10 may include ribs 23 on the inner surface 11 and/or outer surface 12 orientated along the length of the combined fastening removal and retrieval device 10. This configuration will also serve to strengthen the combined fastening removal and retrieval device 10. In yet another embodiment, FIG. 2C, the material may be a laminar composite comprising a polymer layer 24 bonded to a fibrous outer layer 25 that is capable of maintaining any writing on the combined fastening removal and retrieval device 10 from a variety of common writing utensils such as pens, pencils and markers. Alternatively, the material that the combined fastening removal and retrieval device 10 is made of may be any material that can be written on.

The material from which the combined fastening removal and retrieval device 10 is fabricated may be transparent to allow viewing of the entire first object and/or may be provided in a variety of colors to allow quick retrieval or additional organization capability. The material may alternatively be translucent or opaque to allow any markings on the outer surface to be easily read. Additionally, the combined fastening removal and retrieval device 10 may include a design or logo on its surface.

In another embodiment, the combined fastening removal and retrieval device 10 may be composed of a fiber-reinforced polymer. Since the reinforcing fibers will carry the tensile load on the combined fastening removal and retrieval device 10 during fastening removal, the polymer matrix acts only to maintain the position of the fibers within the matrix and may be made of thin flexible polymer.

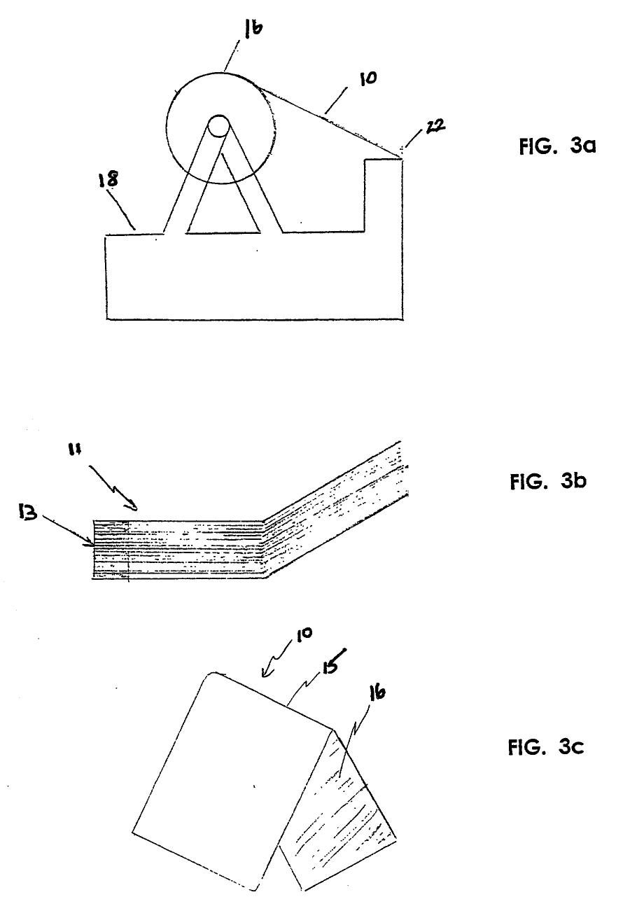

FIGS. 3A and 3B illustrate two different dispensing embodiments of the present invention. FIG. 3A shows a dispensing embodiment wherein the combined fastening removal and retrieval device 10 may be provided in a continuous roll 16. Optionally, the continuous roll 16 may be used in conjunction with a roll holder 18 having a cutting surface 22 for cutting the combined fastening removal and retrieval device 10 from the roll 16. FIG. 3B shows a different dispensing embodiment wherein the roll 16 may be perforated to dispense the fastening removal and retrieval device 10.

Alternatively, the fastening removal and retrieval device 10 may be provided in a stack 11 wherein one end 13 may be adhered together with releasable glue in a manner similar to POST-IT® brand notes.

In a further embodiment, the combined fastening removal and retrieval device 10 may include a light, non-permanent adhesive 16, FIG. 3C, on one side, as in a standard adhesive tape, to facilitate locating and positioning the combined fastening removal and retrieval device 10 on the plurality of objects 20.

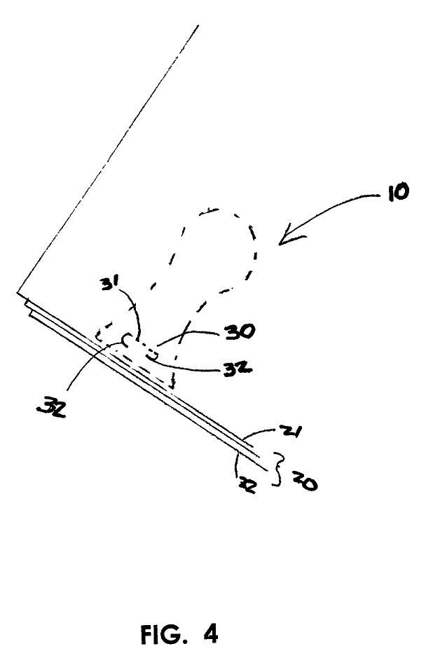

FIG. 4 shows an alternative embodiment of the invention wherein the combined fastening removal and retrieval device 10 may be provided without the crease 15. The absence of the crease 15 may provide for more compact storage. As shown, the combined fastening removal and retrieval device 10 is relatively flat and is placed on the bottom paper 22. Alternatively, the combined fastening removal and retrieval device 10 may be placed on the top paper 21.

In another embodiment, the crease 15 is not present and the user may bend the combined fastening removal and retrieval device 10 around the edge of the plurality of objects 20 being fastened. However, providing the crease 15 provides a convenient usability feature by eliminating the need for the user to bend the material around the edge of the objects 20 being fastened.

For reference, the plurality of objects 20 is shown as a stack of papers 20 having a top paper 21 and a bottom paper 22, although other types of materials such as cardboard, plastic, and other materials commonly fastened together are envisioned. Furthermore, the fastening device is shown as a staple 30 having a front member 31 and legs 32, although other types of fastening devices including nails, clasps, or hooks are envisioned.

In yet another embodiment, the combined fastening removal and retrieval device 10 may be a non-rectangular shape as well. The shape may be determined by ergonomic or esthetic reasons and the selection of the shape is well within the knowledge of one of ordinary skill in the art. Possible shapes contemplated are an hourglass, a triangle, a figure “8”, or any other non-rectangular shape.

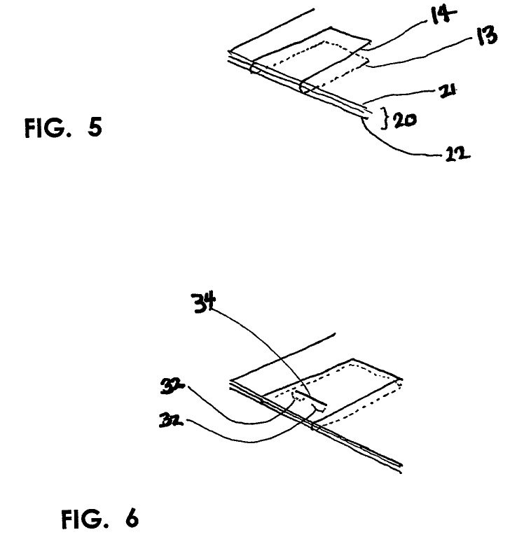

FIGS. 5-8 illustrate a method of using the combined fastening removal and retrieval device 10. FIG. 5 shows the first step of using the combined fastening removal and retrieval device 10 wherein combined fastening removal and retrieval device 10 has been wrapped under a portion of the edge of a plurality of objects 20 being fastened. Alternatively, when the crease 15 is not utilized, the combined fastening removal and retrieval device 10 may be disposed on only the top 21 or the bottom paper 22 of the stack of papers 20.

FIG. 6 shows the configuration of a stapled stack of papers 20 with the combined fastening removal and retrieval device 10. The staple 30 has a front member 34 that is disposed above the front tab end 14 and adjacent to the outer surface 12 of the combined fastening removal and retrieval device 10. The legs 32 of the staple 30 penetrate the front tab end 14, the stack of papers 20, and the rear tab end 13. The legs 32 are bent toward the front member 34 and are adjacent to the outer surface of the rear tab end 13.

In a preferred embodiment of the invention, the width of the combined fastening removal and retrieval device 10 is sufficiently large so that both legs 32 of the staple penetrate through the combined fastening removal and retrieval device 10 although this is not a limitation of the present invention as the combined fastening removal and retrieval device may include only a top or front tab end 14.

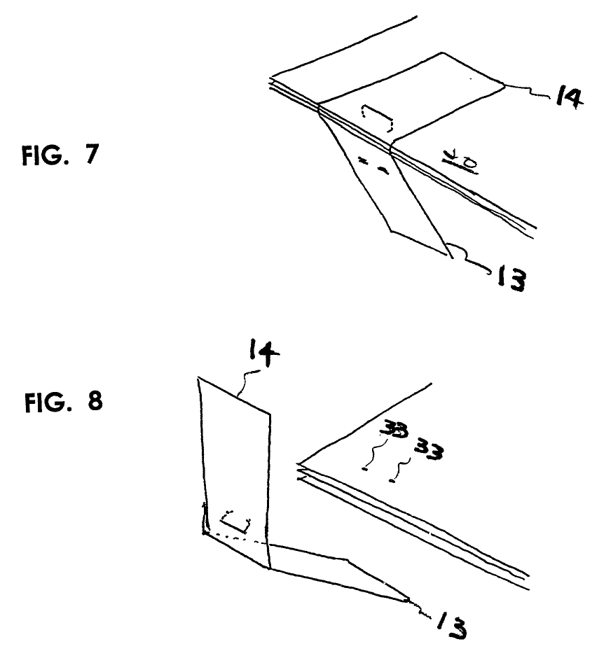

Removal of the staple 30 is shown in FIGS. 7 and 8. The user preferably first grasps the rear tab end 13 and pulls the rear tab end 13 away from the stack of papers 20. FIG. 7 shows the configuration after the user has pulled the rear tab end 13 away from the stack of papers 20. The effect of this step is to partially straighten the legs 32 of staple 30. Partially straightening the legs 32 allows for easier removal of the staple 30 and reduces the damages to the stack of papers 20, but is not required. The user next grasps and pulls the front tab end 14 away from the stack of papers 20.

FIG. 8 shows the configuration after the user has pulled the front tab end 14 away from the stack of papers 20 illustrating that the stack of papers 20 are unstapled without damage, other than the small puncture holes 33 produced by the staple 30 to the top paper 21 or bottom paper 22. Additionally, the staple 30 is still attached to the combined fastening removal and retrieval device 10 thereby reducing the possibility that the staple 30 may lodge and damage nearby office machinery.

Modifications and substitutions by one of ordinary skill in the art are considered to be within the scope of the present invention that is not to be limited except by the claims that follow.

The invention claimed is:

1. A combined fastening removal and retrieval device for removing a fastening device from a plurality of objects, comprising:
a portion of tear-resistant material having an inner surface and an outer surface wherein at least one surface of said combined fastening removal and retrieval device is adapted to be placed between said fastening device and said plurality of objects prior to fastening, for facilitating removal of said fastening device.

2. The combined fastening removal and retrieval device as claimed in claim 1 wherein said tear-resistant material is a polymeric material.

3. The combined fastening removal and retrieval device as claimed in claim 1 wherein said tear-resistant material is a laminate composite.

4. The combined fastening removal and retrieval device as claimed in claim 1 wherein said tear-resistant material is a composite material.

5. The combined fastening removal and retrieval device as claimed in claim 1 wherein said tear-resistant material is a fiber reinforced composite.

6. The combined fastening removal and retrieval device as claimed in claim 1 wherein said tear-resistant material is a laminar composite comprising a polymer layer bonded to a fibrous outer layer, wherein said fibrous outer layer is capable of being written upon using common writing utensils.

7. The combined fastening removal and retrieval device as claimed in claim 2 wherein said tear-resistant material is a polyester film.

8. The combined fastening removal and retrieval device as claimed in claim 6 wherein said tear-resistant material is mylar.

9. The combined fastening removal and retrieval device as claimed in claim 3 wherein said tear-resistant material is a composite material containing fibers embedded a polymer matrix wherein said fibers are oriented generally along said length of said fastening removal device.

10. The combined fastening removal and retrieval device as claimed in claim 1 further including ribs on said inner surface oriented along said length of said fastening removal device.

11. The combined fastening removal and retrieval device as claimed in claim 1 further including ribs on said outer surface oriented along said length of said fastening removal device.

12. The combined fastening removal and retrieval device as claimed in claim 1 wherein said tear-resistant material is transparent.

13. The combined fastening removal and retrieval device as claimed in claim 1 wherein said tear-resistant material is translucent.

14. The combined fastening removal and retrieval device as claimed in claim 13 wherein said tear-resistant material includes at least one of a color and a design.

15. The combined fastening removal and retrieval device as claimed in claim 1 wherein said tear-resistant material is opaque.

16. The combined fastening removal and retrieval device as claimed in claim 1 further including a crease, wherein said combined fastening removal and retrieval device includes a front tab end and a back tab end formed by said crease.

17. The combined fastening removal and retrieval device as claimed in claim 1 wherein said combined fastening removal and retrieval device is rectangular in shape.

18. The combined fastening removal and retrieval device as claimed in claim 1 further comprising at least one section of adhesive material on at least said inner surface of said portion of tear-resistant material, wherein said adhesive material allows said combined fastening removal and retrieval device to be removed.

19. A combined removal and retrieval device for removing a fastening device from a plurality of objects having a top and a bottom comprising a portion of tear-resistant material having a crease, said crease forming a front tab end and a back tab end placed on at least a portion of said top and said bottom of said plurality of objects respectively, wherein said combined removal and retrieval device is placed between said fastening device and said plurality of objects prior to fastening.

20. A combined staple removal and retrieval device comprising:
a staple;
a plurality of objects having a top and a bottom; and
a portion of tear-resistant material having a crease, said crease forming a front tab end and a back tab end placed on at least a portion of said top and said bottom of said plurality of objects respectively, wherein said combined staple removal and retrieval device is placed between said staple and said plurality of objects prior to fastening.

21. A combined fastening removal and retrieval device for removing a fastening device from a plurality of objects, comprising:
a portion of tear-resistant material having an inner surface and an outer surface; and
a portion of adhesive material located on at least said inner surface of said portion of tear-resistant material, wherein at least said inner surface of said combined fastening removal and retrieval device is adapted to be placed between said fastening device and said plurality of objects prior to fastening, for facilitating removal of said fastening device.

22. A method for using a combined fastener remover and retriever device with a plurality of objects comprising the acts of:
enclosing at least a portion of said plurality of objects with a combined fastening removal and retrieval device, said combined fastening removal and retrieval device disposed over at least a top one of said plurality of objects; and
forcing a fastener through said combined fastening removal and retrieval device and said plurality of objects.

23. The method of claim 22 furthering including the act of removing said combined fastening removal and retrieval device comprising the acts of:
grasping said combined fastening removal and retrieval device; and
pulling said combined fastening removal and retrieval device away from said plurality of objects.

24. The method as claimed in claim 23 wherein said act of pulling said combined fastening removal and retrieval device further includes first pulling a back portion of said combined fastening removal and retrieval device away from said plurality of objects, then pulling a front portion of said combined fastening removal and retrieval device away from said plurality of objects wherein during said act of removing, said fastener remains in said fastener remover and retriever device.

25. The method as claimed in claim 23 wherein said act of pulling said combined fastening removal and retrieval device further includes first pulling a front portion of said combined fastening removal and retrieval device away from said plurality of objects, then pulling a back portion of said combined fastening removal and retrieval device away from said plurality of objects wherein during said act of removing, said fastener remains in said fastener remover and retriever device.
